(19) United States
(12) Patent Application Publication
(10) Pub. No.: US 2015/0332315 A1
(43) Pub. Date: Nov. 19, 2015

(54) Click Through Ratio Estimation Model

(71) Applicant: Alibaba Group Holding Limited, Grand Cayman (KY)

(72) Inventors: Jinjie Gu, Hangzhou (CN); Lihui Huang, Hangzhou (CN); Peng Huang, Hangzhou (CN); Wei Zheng, Hangzhou (CN); Feng Lin, Hangzhou (CN)

(21) Appl. No.: 14/712,749

(22) Filed: May 14, 2015

(30) Foreign Application Priority Data
May 14, 2014 (CN) 201410203666.7

(51) Int. Cl. G06Q 30/02

(52) U.S. Cl. CPC G06Q 30/0246

(57) ABSTRACT

Methods and systems for establishing a click-through rate estimation model. A computing device may extract basic characteristics corresponding to a current language channel associated with a server provider. The computing device may combine the basic characteristics to obtain a combination characteristic. The computing device may further obtain an effective high-order characteristic based on the basic characteristics and the combination characteristic and calculate a weight of the effective high-order characteristic. The computing device may generate the CTR estimation model by applying a CTR equation to the weight corresponding to effective high-order characteristic. The implementations may not be limited by human factors, therefore achieving high efficiency in establishing CTR estimation models and high accuracy of the CTR estimation model.

### CROSS REFERENCE TO RELATED PATENT APPLICATIONS

This application claims priority to Chinese Patent Application No. 201410203666.7, filed on May 14, 2014, entitled “Method and Apparatus of Building Click Rate Prediction Model, and Method and System of Providing Information,” which is hereby incorporated by reference in its entirety.

### TECHNICAL FIELD

The present disclosure relates to information rendering and, more specifically, to click through ratio estimation models.

### BACKGROUND

With the globalization of E-commerce, more and more online services provide multiple language channels. For example, an E-commerce site may provide multiple language channels including English, Chinese, Spanish, French, Japanese, and Korean simultaneously. With respect to an E-commerce site, information corresponding to different language channels may be different.

If a user searches goods on an E-commerce site, the user may provide a query to a search engine associated with the E-commerce site. In response to the query, the search engine may select rendering information and evaluate the rendering information using click through ratios (CTR). The search engine may rank the rendering information based on the CTRs and provide results to the user. A ratio between a number of click-through and a number of being rendered may be defined as a CTR. The CTR may be used to characterize a degree of being relevance between the results and the query. For example, the CTR may be used as a predictor for the E-commerce site to select and/or rank the rendering information. Accordingly, a CTR estimation model may be used for estimating the rendering information. In these instances, accuracy of the CTR estimation model may have an impact on the accuracy of information rendering and on quality of user experience associated with E-commerce services.

Currently, CTR estimation models are characterized as feedback-based linear models. For example, effective characteristics may be determined manually from historic characteristics, and then historical click through ratio (HCTR) corresponding to effective characteristics may be obtained manually. Based on the HCTR of the effective characteristics as input characteristics of the linear model, a logistic regression model (LR) may be trained to manually obtain CTR estimation models. However, when an E-commerce site includes multiple language channels, a CTR estimate model has to be established for each of the multiple language channels. In these instances, history characteristics of each language may be determined manually. This approach may be limited by multiple human factors, therefore resulting in low efficiency in establishing CTR estimation models and in low accuracy of the CTR estimation models. Accordingly, there is a need for approaches that automatically establish CTR estimation models for multiple language channels.

### SUMMARY

Implementations of the present disclosure relate to methods and systems for establishing a CTR estimate model. The implementations may automatically establish CTR estimation models for multiple language channels associated with an E-commerce service provider. This Summary is not intended to identify all key features or essential features of the claimed subject matter, nor is it intended to be used alone as an aid in determining the scope of the claimed subject matter.

According to the implementations, a method for providing information may include extracting, by one or more processors of a computing device (e.g., a server terminal), basic characteristics corresponding to a current language channel from historic data, and combining the basic characteristics to obtain one or more combination characteristics. The computing device may obtain an effective high-order characteristic based on the basic characteristics and the combination characteristic. The computing device may further compute a weight of the effective high-order characteristic and generate a CTR estimation model by applying a CTR equation to the weight corresponding to effective high-order characteristic.

In some implementations, the computing device may obtain historical characteristics of the historical data, and segment the historic characteristics based on a smallest semantic unit to obtain basic characteristic. In some instances, the computing device may combine one or more combinations of two basic characteristics of basic characteristics to obtain one or more candidate combination characteristics, and then determine historic CTRs corresponding to the candidate combination characteristics from the historic data containing the historic characteristics. Based on a predetermined weight of the basic characteristic, historic CTRs of the candidate combination characteristics, and a regression function, the computing device may calculate a weight of individual candidate combination characteristics. The computing device may select a candidate combination characteristic corresponding to a weight greater than the predetermined weight.

In some implementations, the computing device may obtain an effective high-order characteristic based on the basic characteristics and the combination characteristics. The computing device may compute a weight of the effective high-order characteristic by selecting one or more candidate high-order characteristics from combinations of basic characteristics and the combination characteristics. The computing device may then select the effective high-order characteristic from candidate high-order characteristics and determine a historic CTR corresponding to the effective high-order characteristic from the historic data containing the historic characteristic. The computing device may further obtain the weight of the effective high-order characteristic using the CTR equation and the historic CTR corresponding to the effective high-order characteristic.

To select the effective high-order characteristic from the candidate high-order characteristics, the computing device may obtain historic CTRs of the candidate high-order characteristics from historic CTRs of historic characteristics, and select a candidate high-order characteristic of a historic CTR greater than a predetermined second value to obtain the effective high-order characteristic. For example, the computing device may apply a loss function and regularized objective function to the high-order characteristic respectively, and select a candidate high-order characteristic as the effective high-order characteristic when the absolute value of a gradient of the objective function and the loss function is greater than a regularization coefficient corresponding the candidate high-order characteristic.

After obtaining the CTR estimation model, the computing device may evaluate whether the CTR estimation model corresponding to the language channel is qualified. If the CTR estimation model corresponding to the language channel is not qualified, the computing device may retrieve additional basic characteristics from the historic data corresponding to the language channel.

In some implementations, to evaluate whether the CTR estimation model corresponding to the language channel is qualified, the computing device may generate receiver operating characteristic (ROC) curve using a weight corresponding to the effective high-order characteristic and calculate an Area Under the Curve (AUC) value of the ROC curve if an amount of the effective high-order characteristic is less than a predetermined value. If the AUC value is greater than a predetermined third value, the computing device may determine that the CTR estimation model corresponding to the language channel is qualified. If the AUC value is less than or equal to the predetermined third value, the computing device may determine that the CTR estimation model corresponding to the language channel is not qualified.

In other implementations, if an amount of the effective high-order characteristic is less than a predetermined value, the computing device may apply the effective high-order characteristic to the CTR estimation model corresponding to the language channel to calculate the estimated CTR of the effective high-order characteristic. The computing device may further obtain historic CTRs of the effective high-order characteristic from historic data containing historic CTRs, and calculate a mean squared error (MSE) between the estimated CTR and the historic CTR of the effective high-order characteristic.

If the MSE is less than a predetermined fourth value, the computing device may determine that the CTR estimation model corresponding to the language channel is qualified. If the MSE is not less than a predetermined fourth value, the computing device may determine that the CTR estimation model corresponding to the language channel is not qualified.

Implements of the present disclosure also relate to systems for establishing a CRT estimation model. The system may include a retrieving module, a computing module, an acquiring module, a retrieving module, and an evaluating module.

The retrieving module configured to extract basic characteristics corresponding the current language channel from historic data and combine the basic characteristics to obtain one or more combination characteristics. The computing module may be configured to obtain an effective high-order characteristic based on the basic characteristics and the combination characteristics, and to compute a weight of the effective high-order characteristic. The acquiring module may be configured to apply the weight corresponding to the effective high-order characteristic to the CTR equation and obtain the CTR estimation model corresponding to the language channel. The retrieving module may be configured to obtain historical characteristics of the historical data and segment the historic characteristics based on a smallest semantic unit to obtain the basic characteristics. The retrieving module may further combine any two of the basic characteristics to obtain one or more candidate combination characteristics. The retrieving module may determine the candidate combination characteristics from historic data containing historic characteristics.

Based on a predetermined weight of the basic characteristics, history CTRs of the candidate combination characteristic, and a regression function, the retrieving module may calculate weights of the candidate combination characteristics, and selecting a candidate combination characteristic corresponding to a weight greater than the predetermined weight as the combination characteristic. The computing module may selecting one or more candidate high-order characteristic from one or more combinations of the basic characteristics and the combination characteristic. The computing device may further select an effective high-order characteristic from the candidate high-order characteristics. The computing device may determine a historic CTR corresponding to the effective high-order characteristic from the historic data containing the historic characteristics and obtain the weight of the effective high-order characteristic using a CTR equation and the historic CTR corresponding to the effective high-order characteristic.

In some implementations, to select the effective high-order characteristic from the candidate high-order characteristics, the computing device may obtain historic CTRs of candidate high-order characteristics from historic CTRs of historic characteristics, and select a candidate high-order characteristic of a historic CTR greater than a predetermined second value to obtain the effective high-order characteristic. For example, the computing device may apply a loss function and regularized objective function to the high-order characteristic respectively, and select the candidate high-order characteristic as the effective high-order characteristic when the absolute value of the gradient of objective function and the loss function is greater than the regularization coefficient corresponding the candidate high-order characteristic.

The evaluating module may be configured to evaluate whether the CTR estimation model corresponding to the language channel is qualified. If the CTR estimation model corresponding to the language channel is not qualified, the retrieving module may extract additional basic characteristics.

If an amount of the effective high-order characteristic is less than a predetermined value, the evaluating module may generate a ROC curve using a weight corresponding to the effective high-order characteristic, and then calculate an AUC value of the ROC curve. If the AUC value is less than or equal to the predetermined third value, the evaluating module may determine that the CTR estimation model corresponding to the language channel is not qualified.

In other implementations, if an amount of the effective high-order characteristic is less than a predetermined value, the computing device may apply the effective high-order characteristic to the CTR estimation model corresponding to the language channel to calculate the estimated CTR of the effective high-order characteristic. The computing device may further obtain a historic CTR of the effective high-order characteristic from the historic data containing historic CTRs and calculate a MSE between the estimated CTR and the historic CTR of the effective high-order characteristic.

If the MSE is less than a predetermined fourth value, the computing device may determine that the CTR estimation model corresponding to the language channel is qualified. If the MSE is not less than a predetermined fourth value, the computing device may determine that the CTR estimation model corresponding to the language channel is not qualified.

Implementations of the present disclosure may also relate to methods for providing information. The implementations may include determining, by a computing device, a language channel corresponding to a query. The computing device may further determine candidate rendering information based on the query to obtain a CTR estimation model of the language channel. The computing device may calculate an estimated CTR of the candidate rendering information using the CRT estimation model. In some implementations, the computing device may rank estimated CTRs in descending order according to the candidate rendering information, and then provide the candidate rendering information and/or the ranking information to a user.

Implementations of the present disclosure may also relate to systems for providing information. A system may include a server terminal and a client terminal. The client terminal may be configured to transmit a query input by a user to the server terminal and provide search results to the user. The server terminal may be configured to determine a language channel corresponding to the query and find candidate rendering information. In some implementations, the server terminal may further obtain a CTR estimation model corresponding to the language channel and calculate estimated CTRs of candidate rendering information using the CRT estimation model. The server terminal may further rank estimated CTRs in descending order according to the candidate rendering information and provide the ranking information and/or rendering information to the user.

Implementations of the present disclosure relate to methods and systems for establishing a CTR estimate model using a computing device. The computing device may extract basic characteristics corresponding a current language channel from historic data and combine the basic characteristics to obtain one or more combination characteristics. The computing device may obtain an effective high-order characteristic based on the basic characteristics and the combination characteristics and compute a weight of the effective high-order characteristic. The computing device may further generate a CTR estimation model by applying the CTR equation to the weight corresponding to effective high-order characteristic. This approach may not be limited by one or more human factors and therefore may lead to high efficiency in establishing CTR estimation models and in high accuracy of the CTR estimation models.

### BRIEF DESCRIPTION OF THE DRAWINGS

The Detailed Description is described with reference to the accompanying figures. The use of the same reference numbers in different figures indicates similar or identical items.

FIG. 1 is a schematic diagram of illustrative computing environment that enables establishing a CTR estimation model.

FIG. 2 is a flow chart of an illustrative process for providing information.

FIG. 3 is a flow chart of an illustrative process for establishing a CTR estimation model.

FIGS. 4 and 5 are schematic diagrams of illustrative computing architectures that enable establishing a CTR estimation model.

### DETAILED DESCRIPTION

Implementations of the present disclosure include technical solutions and beneficial effects described by the accompanying drawings and the following implementations. It should be understood that the implementations described herein only to explain the present disclosure is not intended to limit the present disclosure.

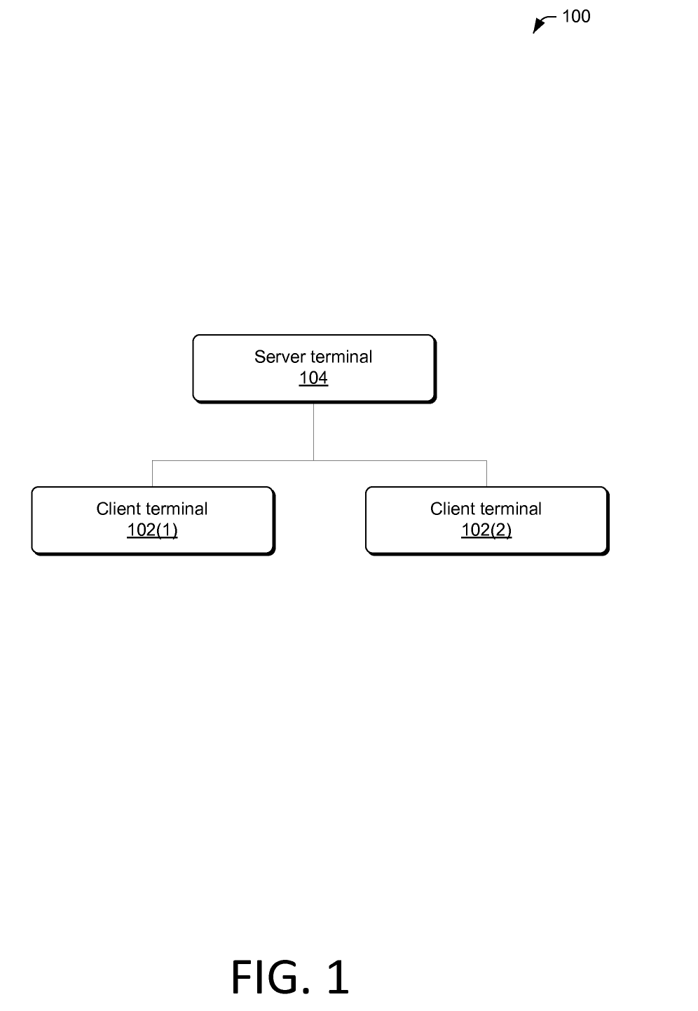

Implementations of the present disclosure relate to methods and systems that automate establish CTR estimation models corresponding to multiple language channels. FIG. 1 is a schematic diagram of illustrative a computing environment 100 that enables establishing a CTR estimation model. The computing environment may include a client terminal 102 (e.g., a client terminal 102(1) and a client terminal 102(2)) and a server terminal 104. The client terminal 102 may be configured to transmit a query input by a user to the server terminal 104 and display search results to the user. The server terminal 104 may be configured to determine a language channel corresponding to the query and candidate rendering information and to obtain a CTR estimation model of the language channel. The server terminal 104 may calculate estimated CTRs of the candidate rendering information using the CRT estimation model and rank the estimated CTRs in descending order according to the candidate rendering information. The server terminal 104 may then provide the candidate rendering information to a user. In some implementations, the rendering information may include commercial advertisements.

If a user searches for goods at an E-commerce site, the user may provide a term as a search query to a search engine. For example, when a user wants to buy men's shirts, the user may enter “men's shirts” as the query. The server terminal 104 may then conduct searches to obtain search results and then provide the search results to the user.

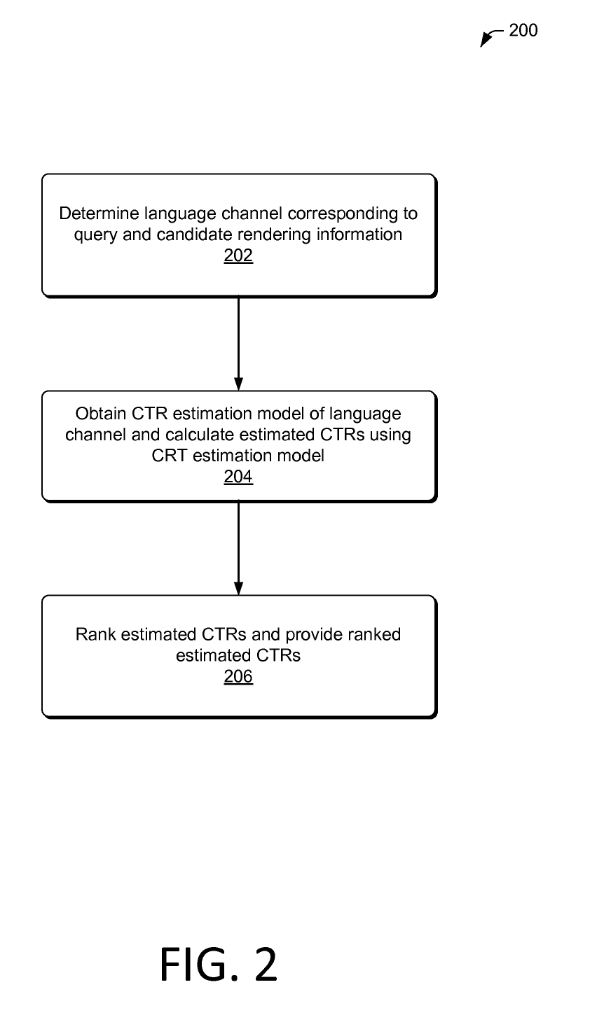

FIG. 2 is a flow chart of an illustrative process 200 for providing information. At 202, the server terminal 104 may determine a language channel corresponding to a query and candidate rendering information based on the query input by a user. For example, the user may input a query for rendering information that the user is interested in. When an E-commerce site associated with the server terminal 104 includes multiple language channels, the server terminal 104 may determine a language channel based on the query. For example, if the user input the query in Spanish, the server terminal 104 may determine that the language channel is the Spanish channel. Then, the server terminal 104 may designate the rendering information in Spanish as a candidate rendering information and provide the candidate rendering information to the user.

At 204, the server terminal 104 may obtain a CTR estimation model of the language channel and calculate estimated CTRs of candidate rendering information using the CRT estimation model. In general, degrees of users' attention may vary with respect to different language channels. For example, in the English channel at the E-commerce site, the best sale of mobile devices belongs to Huawei cell phones, while on the Korean channel, the best sale of mobile devices belongs to Samsung. In other words, in the English Channel CTR (Huawei)>CTR (Samsung), and in the Korean channel CTR (Samsung)>CTR (Huawei). Accordingly, different language channels may corresponds to different CTR estimation models.

When an E-commerce site includes multiple language channels, a CTR estimate model has to be established for each of the multiple language channels. According to the query entered by the user, the server terminal 104 may determine a language channel corresponding to the query and candidate rendering information. The server terminal 104 may further obtain a CTR estimation model of the language channel and calculate estimated CTRs of the candidate rendering information using CRT estimation mode.

In some implementations, the CTR estimation model may be represented using a CTR equation:

$$prob ( 1 \vert X ) = \frac{1}{1 + {e}^{- ( {ω}_{0} + Σ {x}_{i} {ω}_{i} )}} \qquad ( 1 )$$

In Equation 1 above, xᵢ, represents the effective value of the high-order characteristic, which is a discrete value. When candidate rendering information exists, an effective high-order characteristic may be characterized by 1. When the candidate rendering information does not exists, the effective high-order characteristic may be characterized by 0. X is characterized by a set of high-order effective values of xᵢ. ω, represents the i^{th} effective high-order characteristic. A weight of effective high-order characteristic may be calculated using the CTR estimation model, wherein the value of the weight ranging from zero to R (a real number). ω₀ represents the initial value. The effective high-order characteristic may include one or more characteristics. For example, the effective high-order characteristic may include the query, the rendering information, and/or a feature of the rendering information.

When the server terminal 104 calculates estimated CTR using the candidate rendering information, the server terminal 104 may determine that the candidate rendering information includes the effective high-order characteristic of the CTR estimation model. In other words, the server terminal 104 may determine xᵢ, and then apply the CTR estimation model to estimated CTRs of the rendering information.

At 206, the server terminal 104 may rank estimated CTRs in descending order according to the candidate rendering information and provide the candidate rendering information to a user. In some implementations, the server terminal 104 may calculate estimated CTRs of each portion of the candidate rendering information and then rank portions of the candidate rendering information based on estimated CTRs of the portions. The server terminal 104 may select a portion of the rendering information and provide the portion to the user. In some implementations, the server terminal 104 may determine an amount of information for user review based on a demand of the user. For example, the server terminal 104 may select the rendering information corresponding to the estimated CTRs ranking from the first to a predetermined number (e.g., 10^{th}). The server terminal 104 may collect and analyze an individual CTR having the effective high-order characteristic in a predetermined time period. In another words, the server terminal 104 may determine a ratio between a number of click-through and a number of rendering with respect to an individual effective high-order characteristic. Since the rendering information may correspond to one or more effective high-order characteristics, the CTR of the rendering information and/or CTR of effective high-order characteristic may be calculated. Then the server terminal 104 may store effective high-order characteristics and the related CTRs as historic data for establishing additional effective high-order characteristics. The predetermined time period may be determined according to actual needs, for example, 20 days or one month.

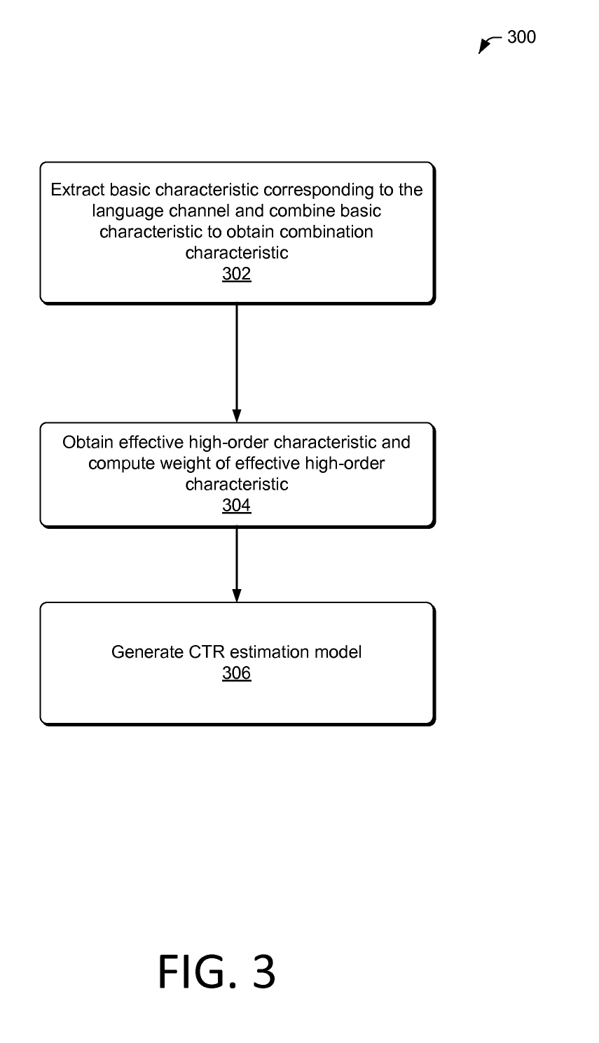

The server terminal 104 may establish CTR estimation models in various methods. FIG. 3 is a flow chart of an illustrative process for establishing a CTR estimation model. At 302, the server terminal 104 may extract basic characteristics corresponding to the current language channel from historic data and combine the basic characteristics to obtain one or more combination characteristics. In some implementations, the current language channel may be any of the language channels provided by the E-commerce site. The historic data corresponding to the current language channel may include CTRs corresponding to effective high-order characteristics in a predetermined time period. The server terminal 104 may determine the CTR in the predetermined time period; therefore, effective high-order characteristics of the historic data may include historic characteristics, and CTRs of the historic data may include historic CTRs.

In some implementations, the server terminal 104 may further translate historic data in other languages to obtain historic data of other languages corresponding to the current language channel. The server terminal 104 may further retrieve the historic data corresponding to the current language from other sites. In these instances, the historic data general is off-line data, which may be stored in a predetermined database. Historic characteristics of the historical data may not be the smallest semantic unit, and therefore one or more basic characteristics may be extracted from the historic characteristic. Then, the server terminal 104 may combine the basic characteristics to obtain a combination characteristic, which may include two or more basic characteristics.

At 304, the server terminal 104 may obtain an effective high-order characteristic based on the basic characteristics and one or more combination characteristics. The server terminal 104 may further compute a weight of the effective high-order characteristic. In some implementations, the server terminal 104 may combine the basic characteristics and the combination characteristics to obtain the effective high-order characteristic for establishing the CTR estimation model. For example, as for a shirt, a user may pay more attention to characteristics including colors, styles, and brands than characteristics merely include colors. According, the server terminal 104 may obtaining an effective high-order characteristic based on multiple basic characteristics and/or the combination characteristics.

At 306, the server terminal 104 may generate a CTR estimation model by applying a CTR equation to the weight corresponding to the effective high-order characteristic. For example, the server terminal 104 may generate the CTR estimation model by applying Equation (1) to the weight corresponding to the effective high-order characteristic. Therefore, the server terminal 104 may establish CTR estimation models for individual language channels. This approach may not be limited by human factors; therefore this approach may lead to high efficiency in establishing CTR estimation models and in high accuracy of the CTR estimation models. In some implementations, the server terminal 104 may establish a combined CTR estimation model for multiple language channels.

In some implementations, to extract basic characteristics corresponding to the current language channel, the server terminal 104 may obtain historical characteristics of the historical data and segment the historic characteristics based on a semantic unit (e.g., the smallest unit) to obtain basic characteristics. For example, the historical characteristics acquired include “otaku games cheap clothes,” which may be divided into units including “otaku,” “game,” “cheap,” and “clothes.” These units may be used as the basic characteristics.

In some implementations, the combination characteristic may include a combination of any two of the basic characteristics as a candidate combination characteristic. For example, the server terminal 104 may determine candidate combination characteristics from the historic data containing the historic characteristics. Based on a predetermined weight of the basic characteristics, history CTRs of the candidate combination characteristics, and a regression function, weights of the candidate combination characteristics may be calculated. In some implementations, the server terminal 104 may selecting candidate combination characteristics corresponding to a weight greater than the predetermined weight as the combination characteristic. The server terminal 104 may combine any two basic characteristics to obtain combination characteristics.

In some implementations, a number of the combination characteristics may be high and some combination characteristics may have negative impact on establishing CTR estimation models. The server terminal 104 may determine candidate combination characteristics from historic data and obtain historic CTRs from historic data containing the candidate combination characteristics. In these instances, the regression function may be represented as follow:

$$F ( X ) = f ( X ) + {\sum }_{i , j = 1}^{n} {ω}_{ij} {x}_{ij} , f ( X ) = {ω}_{0} + {\sum }_{i = 1}^{n} {ω}_{i} {x}_{i} ,$$

wherein F (X) represents a historical CTR of a candidate combination of characteristics ij, ωᵢ represents the basis of the pre-feature i right weight, ω₀ represents the initial value, xᵢ, represents the value of the basic characteristics of i, X is the value of n the basis of the characteristics xᵢ collection, ωᵢⱼ represents a preset weigh of the combination of characteristic ij, xᵢⱼ represents the value of the combination of characteristic ij.

The server terminal 104 may obtaining an effective high-order characteristic based on the basic characteristics and the combination characteristics and compute a weight of the effective high-order characteristic. In some implementations, the server terminal 104 may select candidate high-order characteristics from a combination of basic characteristics and the combination characteristics and select an effective high-order characteristic from candidate high-order characteristics. The server terminal 104 may determine the candidate combination characteristics from the historic data containing the historic characteristics and obtain weights of effective high-order characteristics using the CTR equation and the historic CTRs corresponding to the effective high-order characteristics.

The server terminal 104 may combines basic characteristics to obtain candidate high-order characteristics and combine multiple combination characteristics to obtain candidate combination characteristics. In some implementations, the server terminal 104 may combine the combination characteristics and the basic characteristics to obtain the candidate combination characteristics.

In Equation (1), if historical CTRs of effective high-order characteristics and xᵢ, are determined, the server terminal 104 may determine ωᵢ.

In some implementations, to select an effective high-order characteristic from candidate high-order characteristics, the server terminal 104 may adopt at least two approaches. As for the first approach, the server terminal 104 may obtain historic CTRs of candidate high-order characteristics from historic CTRs of historic characteristics. The server terminal 104 may further select the candidate high-order characteristics of a historic CTR greater than a predetermined second value to obtain the effective high-order characteristic.

When the historic CTR is less than a predetermined second value, the candidate high-order characteristic may be ignored with respect to establishing the CTR estimation model. Therefore, the server terminal 104 may select a candidate high-order characteristic of a historic CTR greater than the predetermined second value to obtain the effective high-order characteristic. The predetermined second value may be set according to actual needs.

As for the second approach, the server terminal 104 may apply a loss function and regularized objective function to high-order characteristics respectively. The server terminal 104 may select a candidate high-order characteristic as the effective high-order characteristic when the absolute value of the gradient of objective function and the loss function is greater than the regularization coefficient corresponding the candidate high-order characteristic.

The objective function may be provided as follow:

$$L ( ω , x ) + Ω ( ω ) = {\sum }_{i = 0}^{n} log ( 1 + {e}^{- {y}_{i} f ( {X}_{i} )} ) + C {\sum }_{j = 0}^{m} \vert {ω}_{j} \vert ,$$

wherein, L (ω, x) represents the loss function, Ω(ω) is regularization term,

$$f ( {X}_{i} ) = {ω}_{0} + {\sum }_{j = 1}^{m} {ω}_{j} {x}_{j} ,$$

Xᵢ represents the set value of the i^{th} display information included in the j^{th} candidate higher-order characteristic, ωⱼ represents the preset weight of the j^{th} candidate high-order characteristic, xⱼ represents the j^{th} candidate value high-order characteristic, yᵢ represents the i^{th} display CTR history information, the total number of higher order m as a candidate characteristic, n represents the number of display information. In these instances, when

$$\vert \frac{\partial L}{\partial {ω}_{j}} \vert > C ,$$

since the j^{th} candidate is most likely high-order characteristic suitable for establishing a CTR estimation model, the server terminal 104 may select this part of the candidate higher-order characteristic as an effective high-order characteristic.

After obtaining the CTR estimation model, the server terminal 104 may evaluate whether the CTR estimation model corresponding to the language channel is qualified. If the CTR estimation model corresponding to the language channel is not qualified, the process 300 may go back to operation 302.

If the CTR estimation model is qualified, the server terminal 104 may apply the CTR estimation model to the method for providing information. Then, the server terminal 104 may store CTRs of effective high-order characteristics in a predetermined time period for further establishing CTR estimation models.

In some implementation, to evaluate whether the CTR estimation model corresponding to the language channel is qualified, the server terminal 104 may adopt at least two methods. As for the first method, if an amount of the effective high-order characteristic is less than a predetermined value, the server terminal 104 may generate a ROC curve using a weight corresponding to the effective high-order characteristic and calculate an AUC value of the ROC curve. If the AUC value is greater than a predetermined third value, the server terminal 104 may determine the CTR estimation model corresponding to the language channel. If the AUC value is less than or equal to the predetermined third value, the server terminal 104 may determine that the CTR estimation model corresponding to the language channel is not qualified.

The number of effective high-order characteristics may have impact on whether the established CTR estimation model is qualified. For example, if the number is limited, accuracy of the CTR estimation model may be affected. Therefore, the server terminal 104 may determine whether the number of effective high-order characteristics is greater than a predetermined value.

If the number is not greater than the predetermined value, the server terminal 104 may adopt the first method for establishing the CTR estimation model. In some implementations, the setting value may be set according to actual needs, for example, to 10,000, 50,000, and 100,000 and so on, and the predetermined third threshold may be set to any value between 0.5 and 1. The greater the value of the predetermined third value, the better estimation generated by the CTR estimation model.

As for the second method, if an amount of the effective high-order characteristic is less than a predetermined value, the server terminal 104 may apply the effective high-order characteristic to the CTR estimation model corresponding to the language channel to calculate estimated CTRs of the effective high-order characteristic. The server terminal 104 may obtain historic CTRs of the effective high-order characteristic from historic data containing historic CTRs and calculate a MSE between the estimated CTRs and the historic CTRs of the effective high-order characteristics.

If the MSE is less than a predetermined fourth value, the server terminal 104 may determine that the CTR estimation model corresponding to the language channel is qualified. If the AUC value is less than or equal to the predetermined third value, the server terminal 104 may determine that the CTR estimation model corresponding to the language channel is not qualified.

If an amount of the effective high-order characteristic is less than a predetermined value, the server terminal 104 may calculate the MSE between the estimated CTRs and the historic CTRs of the effective high-order characteristic. If the MSE is more than the predetermined fourth value, the server terminal 104 may determine that the CTR estimation model is not qualified. In these instances, the predetermined fourth value may be determined based on actual needs. The MSE of the effective high-order characteristic may be calculated using the equation:

$$MSE = \frac{1}{n} {\sum }_{i = 1}^{n} {( {\hat{Y}}_{i} - {Y}_{i} )}^{2}$$

wherein Ŷᵢ represents the estimated CTR of i^{th} effective high order characteristic, Yᵢ is the historic CTR of i^{th} historical high-order characteristic.

Based on the two methods above, an ACT value may indicate the ranking ability on the rendering information while the MSE value may indicate the distance between the real value and estimated value. Table 1 indicates a comparison between estimated CTRs using the implementations of the present disclosure and using the conventional techniques.

| | the CTR estimation model | the CTR estimation model |
|---|---|---|
| | established using | established using conventional |
| | implementations herein | techniques |
| AUC | 0.8918 | 0.6810 |
| MSE | 0.00332 | >0.006 |

As illustrated above, the AUC value of the implementations herein is close to 0.9, which is a relatively high value, while the MSE was close to the average click-through rate. As compared to those under the conventional techniques, CTR estimation models established using implementations herein achieve better results.

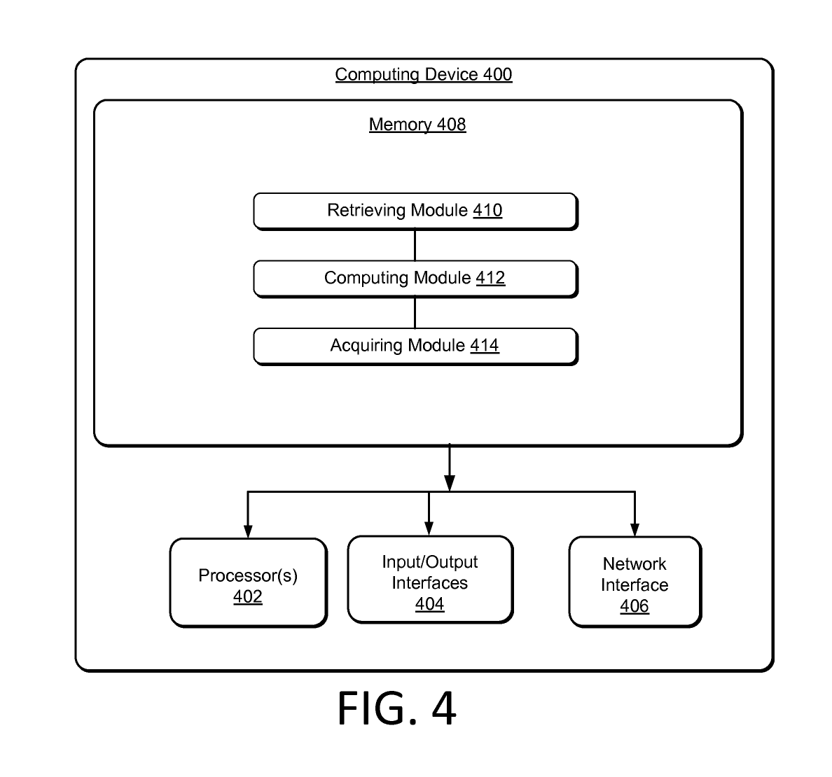

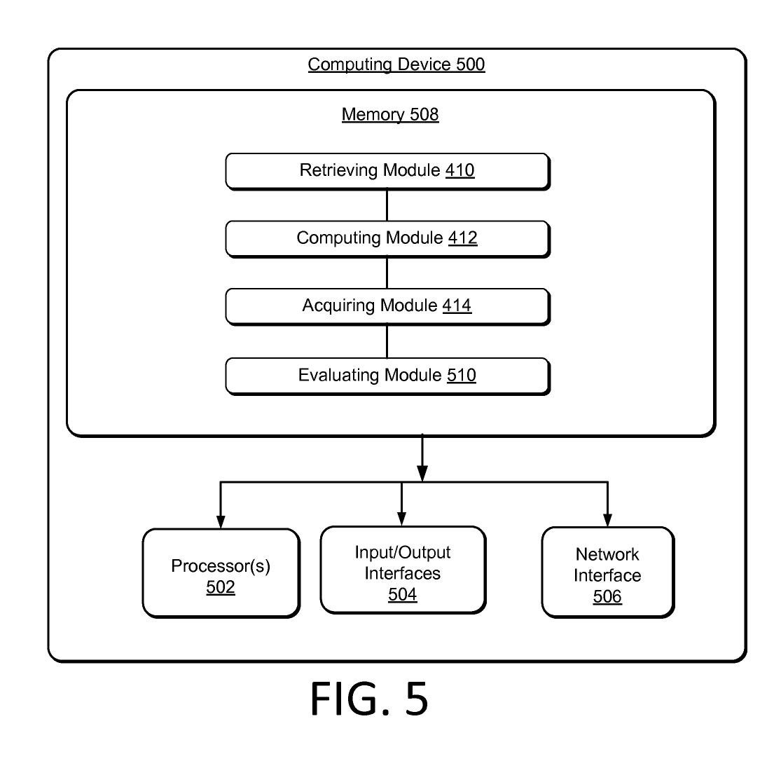

FIGS. 4 and 5 are schematic diagrams of illustrative computing architectures that enable establishing a CTR estimation model. FIG. 4 is a diagram of a computing device 400. The computing device 400 may be a server terminal. In one exemplary configuration, the computing device 400 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 508 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a retrieving module 410, a computing module 412, and an acquiring module 414.

The retrieving module 410 may be configured to extract basic characteristics corresponding the current language channel from historic data and combine the basic characteristics to obtain one or more combination characteristics.

The computing module 412 may be configured to obtain an effective high-order characteristic based on the basic characteristics and the combination characteristics and then compute a weight of the effective high-order characteristic.

The acquiring module 414 may be configured to generate the CTR estimation model by applying the CTR equation to the weight corresponding to effective high-order characteristic.

The retrieving module 410 may further obtain historical characteristics of the historical data and segment the historic characteristics based on a semantic unit to obtain basic characteristics. The retrieving module 410 may combine any two of the basic characteristics to obtain candidate combination characteristics. For example, the retrieving module 410 may determine the candidate combination characteristic from historic data containing historic characteristics. Based on predetermined weights of the basic characteristics, history CTRs of the candidate combination characteristics, and a regression function, the server terminal may calculate weights of candidate combination characteristics and selecting a candidate combination characteristic corresponding to a weight greater than the predetermined weight as the combination characteristic.

The computing module 412 may select a candidate high-order characteristic from a combination of basic characteristics and the combination characteristic and select effective high-order characteristic from candidate high-order characteristics. For example, the computing device 412 may determine the candidate combination characteristic from the historic data containing the historic characteristics and obtain the weight of the effective high-order characteristic using the CTR equation and the historic CTR corresponding to the effective high-order characteristic.

In some implementations, to select the effective high-order characteristic from candidate high-order characteristics, the computing module 412 may obtain historic CTRs of candidate high-order characteristics from the historic CTRs of historic characteristics and select a candidate high-order characteristic of a historic CTR greater than a predetermined second value as the effective high-order characteristic.

The computing device 400 may apply a loss function and regularized objective function to the high-order characteristic respectively and select the candidate high-order characteristic as the effective high-order characteristic when the absolute value of the gradient of objective function and the loss function is greater than the regularization coefficient corresponding the candidate high-order characteristic.

FIG. 5 is a diagram of a computing device 500. The computing device 500 may be a server terminal. In one exemplary configuration, the computing device 500 includes one or more processors 502, input/output interfaces 504, network interface 506, and memory 508.

The memory 508 may include computer-readable media in the form of volatile memory, such as random-access memory (RAM) and/or non-volatile memory, such as read only memory (ROM) or flash RAM. The memory 508 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 508 in more detail, the memory 508 may include a retrieving module 410, a computing module 412, an acquiring module 414, and an evaluating module 510.

The evaluation module 510 may be configured to evaluate whether the CTR estimation model corresponding to the language channel is qualified. If the CTR estimation model corresponding to the language channel is not qualified, the computing device may retrieve additional basic characteristics from the historic data corresponding to the language channel.

In some implementations, to evaluate whether the CTR estimation model corresponding to the language channel is qualified, the computing device may generate a ROC curve using a weight corresponding to the effective high-order characteristic and calculate an AUC value of a ROC curve if an amount of the effective high-order characteristic is less than a predetermined value. If the AUC value is greater than a predetermined third value, the computing device may determine that the CTR estimation model corresponding to the language channel is qualified. If the AUC value is less than or equal to the predetermined third value, the computing device may determine that the CTR estimation model corresponding to the language channel is not qualified.

In other implementations, if an amount of the effective high-order characteristic is less than a predetermined value, the computing device may apply the effective high-order characteristic to the CTR estimation model corresponding to the language channel to calculate the estimated CTR of the effective high-order characteristic. The computing device may further obtain a historic CTR of the effective high-order characteristic from the historic data containing historic CTRs, and calculate a MSE between the estimated CTR and the historic CTR of the effective high-order characteristic.

If the MSE is less than a predetermined fourth value, the computing device may determine that the CTR estimation model corresponding to the language channel is qualified. If the MSE is not less than a predetermined fourth value, the computing device may determine that the CTR estimation model corresponding to the language channel is not qualified.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A computer-implemented method for establishing a click-through rate (CTR) estimation model, the method comprising:
extracting, by one or more processors of a computing device, a plurality of basic characteristics corresponding to a language channel from historic data;
combining, by the one or more processors, the plurality of basic characteristics to obtain one or more combination characteristics;
obtaining, by the one or more processors, an effective high-order characteristic based on the plurality of basic characteristics and the one or more combination characteristics;
computing, by the one or more processors, a weight of the effective high-order characteristic; and
generating, by the one or more processors, a CTR estimation model by applying a CTR equation to the weight of the effective high-order characteristic.

2. The method of claim 1, wherein the extracting from the plurality of basic characteristics corresponding the language channel comprises:
obtaining a plurality of historical characteristics of historical data; and
segmenting the plurality of historic characteristics based on a semantic unit to obtain the plurality of basic characteristics.

3. The method of claim 1, wherein the combining the plurality of basic characteristics to obtain the one or more combination characteristics comprises:
combining at least two basic characteristics of the plurality of basic characteristics to obtain an individual candidate combination characteristic of a plurality of candidate combination characteristics;
determining historic CTRs of the plurality of candidate combination characteristics from historic data containing a plurality of historic characteristics;
calculating weights of the plurality of candidate combination characteristics based on a predetermined weight of an individual basic characteristic, the historic CTRs of the plurality of candidate combination characteristics, and a regression function; and
designating a candidate combination characteristic of the plurality of candidate combination characteristics that corresponds to a weight greater than the predetermined weight as the combination characteristic.

4. The method of claim 1, wherein the obtaining the effective high-order characteristic based on the plurality of basic characteristics and the one or more combination characteristics and the computing the weight of the effective high-order characteristic comprises:
selecting a plurality of candidate effective high-order characteristics from a combination of the plurality of basic characteristics and the one or more combination characteristics;
selecting the effective high-order characteristic from a plurality of candidate high-order characteristic;
determining a historic CTR corresponding to the effective high-order characteristic from historic data containing a plurality of historic characteristics; and
obtaining the weight of the effective high-order characteristic using the CTR equation and the historic CTR corresponding to the effective high-order characteristic.

5. The method of claim 4, wherein the selecting the effective high-order characteristic from a plurality of candidate high-order characteristic comprises:
obtaining historic CTRs of the plurality of candidate effective high-order characteristics from a plurality of historic CTRs of the plurality of historic characteristics;
selecting a high-order characteristic having a historic CTR greater than a predetermined second value associated with the plurality of candidate effective high-order characteristics; and
applying a loss function and a regularized objective function to the high-order characteristic respectively; and
selecting a candidate high-order characteristic as the effective high-order characteristic when an absolute value of a gradient of the objective function and the loss function is greater than a regularization coefficient corresponding to the candidate high-order characteristic.

6. The method of claim 1, further comprising:
evaluating whether the CTR estimation model corresponding to the language channel is qualified; and
retrieving additional basic characteristics from historic data corresponding to the language channel in response to a determination that the CTR estimation model corresponding to the language channel is not qualified.

7. The method of claim 6, wherein the evaluating whether the CTR estimation model corresponding to the language channel is qualified comprises:
in response to a determination that an amount of the effective high-order characteristic is less than a predetermined value:
generating a receiver operating characteristic curve (ROC) using the weight corresponding to the effective high-order characteristic;
calculating an area under the curve (AUC) value of the ROC curve;
determining the CTR estimation model corresponding to the language channel is qualified in response to a determination that the AUC value is greater than a predetermined third value; and
determining that the CTR estimation model corresponding to the language channel is not qualified in response to a determination that the AUC value is less than or equal to the predetermined third value; or
If an amount of the effective high-order characteristic is less than a predetermined value:
applying the CTR estimation model to corresponding to the language channel to the effective high-order characteristic to calculate the estimated CTR of the effective high-order characteristic;
obtaining a historic CTR of the effective high-order characteristic from the historic data containing the historic CTR;
calculating a mean squared error (MSE) between the estimated CTR and the historic CTR of the effective high-order characteristic;
determining that the CTR estimation model corresponding to the language channel is qualified If the MSE is less than a predetermined fourth value; and
determining that the CTR estimation model corresponding to the language channel is not qualified If the MSE is greater than or equal to a predetermined fourth value.

8. A system for establishing a CTR estimation model, the system comprising:
one or more processors; and
memory to maintain a plurality of components executable by the one or more processors, the plurality of components comprising:
a retrieving unit configured to:
extract a plurality of basic characteristics corresponding to a language channel from historic data, and
combine the plurality of basic characteristics to obtain one or more combination characteristics,
a computing unit configured to:
obtain an effective high-order characteristic based on the plurality of basic characteristics and the one or more combination characteristics, and
compute a weight of the effective high-order characteristic, and
an acquiring unit configured to apply a CTR equation to the weight corresponding to the effective high-order characteristic to obtain the CTR estimation model corresponding to the language channel.

9. The system of claim 8, wherein the retrieving unit is further configured to:
obtain historical characteristics of the historical data; and
segment historic characteristics based on a semantic unit to obtain the plurality of basic characteristics.

10. The system of claim 8, wherein the retrieving unit is further configured to:
combine at least two basic characteristics of the plurality of basic characteristics to obtain an individual candidate combination characteristic of a plurality of candidate combination characteristics;
determine historic CTRs of the plurality of candidate combination characteristics from historic data containing a plurality of historic characteristics;
calculate weights of the plurality of candidate combination characteristics based on a predetermined weight of an individual basic characteristic, the historic CTRs of the plurality of candidate combination characteristics, and a regression function; and
designate a candidate combination characteristic of the plurality of candidate combination characteristics that corresponds to a weight greater than the predetermined weight as the combination characteristic.

11. The system of claim 8, wherein the computing unit is further configured to:
select a plurality of candidate effective high-order characteristics from a combination of the plurality of basic characteristics and the one or more combination characteristics;
select the effective high-order characteristic from a plurality of candidate high-order characteristic;
determine a historic CTR corresponding to the effective high-order characteristic from historic data containing a plurality of historic characteristics; and
obtain the weight of the effective high-order characteristic using the CTR equation and the historic CTR corresponding to the effective high-order characteristic.

12. The system of claim 11, wherein the selecting the effective high-order characteristic from a plurality of candidate high-order characteristic comprises:
obtaining historic CTRs of the plurality of candidate effective high-order characteristics from a plurality of historic CTRs of the plurality of historic characteristics;
selecting a high-order characteristic having a historic CTR greater than a predetermined second value associated with the plurality of candidate effective high-order characteristics; and
applying a loss function and a regularized objective function to the high-order characteristic respectively; and
selecting a candidate high-order characteristic as the effective high-order characteristic when an absolute value of a gradient of the objective function and the loss function is greater than a regularization coefficient corresponding to the candidate high-order characteristic.

13. The system of claim 8, wherein the plurality of components further comprise an evaluation module configured to:
evaluate whether the CTR estimation model corresponding to the language channel is qualified; and
retrieve additional basic characteristics from historic data corresponding to the language channel in response to a determination that the CTR estimation model corresponding to the language channel is not qualified.

14. The system of claim 13, wherein the evaluation module is further configured to:
in response to a determination that an amount of the effective high-order characteristic is less than a predetermined value:
generate a receiver operating characteristic curve (ROC) using the weight corresponding to the effective high-order characteristic,
calculate an area under the curve (AUC) value of the ROC curve,
in response to a determination that the AUC value is greater than a predetermined third value, determine the CTR estimation model corresponding to the language channel is qualified, and
in response to a determination that the AUC value is less than or equal to the predetermined third value, determine that the CTR estimation model corresponding to the language channel is not qualified; or
If an amount of the effective high-order characteristic is less than a predetermined value:
apply the CTR estimation model to corresponding to the language channel to the effective high-order characteristic to calculate the estimated CTR of the effective high-order characteristic,
obtain a historic CTR of the effective high-order characteristic from the historic data containing the historic CTR,
calculate a mean squared error (MSE) between the estimated CTR and the historic CTR of the effective high-order characteristic,
determine that the CTR estimation model corresponding to the language channel is qualified If the MSE is less than a predetermined fourth value,
determine that the CTR estimation model corresponding to the language channel is not qualified If the MSE is greater than or equal to a predetermined fourth value.

15. A method for providing information, the method comprising:
determining, by one or more processors of a computing device, a language channel corresponding to a search query;
determining, by the one or more processors, candidate rendering information based on the search query;
obtaining, by the one or more processors, a CTR estimation model of the language channel;
calculating, by the one or more processors, a plurality of estimated CTRs of the candidate rendering information using a CRT estimation model;
ranking, by the one or more processors, the plurality of estimated CTRs in a descending order based on the candidate rendering information; and
providing, by the one or more processors, the candidate rendering information and the plurality of ranked estimated CTRs to a user.

16. The method of claim 15, wherein the CRT estimation model is established by:
extracting from a plurality of basic characteristics corresponding to a language channel;
combining the plurality of basic characteristics to obtain one or more combination characteristics;
obtaining an effective high-order characteristic based on the plurality of basic characteristics and the combination characteristic;
computing a weight of the effective high-order characteristic; and
generating the CTR estimation model by applying a CTR equation to the weight of the effective high-order characteristic.

17. The method of claim 16, wherein the combining the plurality of basic characteristics to obtain the one or more combination characteristics comprises:
combining at least two basic characteristics of the plurality of basic characteristics to obtain an individual candidate combination characteristic of a plurality of candidate combination characteristics;
determining historic CTRs of the plurality of candidate combination characteristics from historic data containing a plurality of historic characteristics;
calculating weights of the plurality of candidate combination characteristics based on a predetermined weight of an individual basic characteristic, the historic CTRs of the plurality of candidate combination characteristics, and a regression function; and
designating a candidate combination characteristic of the plurality of candidate combination characteristics that corresponds to a weight greater than the predetermined weight as the combination characteristic.

18. The method of claim 16, wherein the extracting from the plurality of basic characteristics corresponding to the language channel comprises:
obtaining a plurality of historical characteristics of historical data; and
segmenting the plurality of historic characteristics based on a semantic unit to obtain the plurality of basic characteristics.

19. The method of claim 16, wherein the obtaining the effective high-order characteristic based on the plurality of basic characteristics and the one or more combination characteristics and the computing the weight of the effective high-order characteristic comprises:
selecting a plurality of candidate effective high-order characteristics from a combination of the plurality of basic characteristics and the one or more combination characteristics;
selecting the effective high-order characteristic from a plurality of candidate high-order characteristic;
determining a historic CTR corresponding to the effective high-order characteristic from historic data containing a plurality of historic characteristics; and
obtaining the weight of the effective high-order characteristic using the CTR equation and the historic CTR corresponding to the effective high-order characteristic.

20. The method of claim 16, further comprising:
evaluating whether the CTR estimation model corresponding to the language channel is qualified; and
retrieving additional basic characteristics from historic data corresponding to the language channel in response to a determination that the CTR estimation model corresponding to the language channel is not qualified.
